(19) United States
(12) Patent Application Publication
(10) Pub. No.: US 2019/0239215 A1
(43) Pub. Date: Aug. 1, 2019

(54) COMMUNICATION METHOD, TERMINAL AND NETWORK DEVICE

(71) Applicant: GUANGDONG OPPO MOBILE TELECOMMUNICATIONS CORP., LTD, Dongguan, Guangdong (CN)

(72) Inventors: Yanan LIN, Dongguan, Guangdong (CN); Hua XU, Ottawa (CA)

(21) Appl. No.: 16/338,046

(22) PCT Filed: Mar. 24, 2017
(86) PCT No.: PCT/CN2017/078147

§ 371 Date: Mar. 29, 2019

(51) Int. Cl. H04W 72/04; H04L 5/00

(52) U.S. Cl. CPC H04W 72/0413; H04L 5/0055; H04L 5/0048; H04W 72/0446

(57) ABSTRACT

Provided are a communication method, a terminal and a network device. The communication method comprises: a terminal determining to transmit first uplink control information and second uplink control information in a target time unit, wherein the terminal uses a first and a second uplink control channel when individually transmitting the first and second uplink information in the target time unit, respectively, and the number of time domain symbols included in the first uplink control channel is greater than that in the second uplink control channel; the terminal using, in the target time unit, target time domain symbols in the first uplink control channel to transmit the second uplink control information, and using the other domain symbols to transmit the first uplink control information, wherein the target time domain symbols are at least some time domain symbols used for transmitting reference symbols in the first uplink control channel.

### TECHNICAL FIELD

The present disclosure relates to the field of communication, and particularly to a communication method, a terminal and a network device.

### BACKGROUND

In a new radio (NR) system, such as a 5G communication system, there are two kinds of Physical Uplink Control Channels (PUCCHs) that supports two kinds of time lengths. One of them is called short Physical Uplink Control Channel (short-PUCCH), and the other is called long Physical Uplink Control Channel (long-PUCCH). Among them, the short-PUCCH may include one or two time domain symbols, and the long-PUCCH may include at least 4 time domain symbols.

In NR systems, feedback information corresponding to different traffic channels may be transmitted by using PUCCHs with different lengths. When the feedback information of different traffic channels is transmitted by using PUCCHs of different lengths, and the PUCCHs of different lengths are located in the same time unit, how to transmit the feedback information of the different traffic channels is a technical problem to be solved.

### SUMMARY

The present disclosure provides a communication method, a terminal and a network device, which enable the terminal to simultaneously transmit multiple uplink control information in the same time unit, wherein multiple uplink control information are separately transmitted using uplink physical control channels of different lengths, thereby improving the utilization rate of resources.

According to a first aspect of the present disclosure, a communication method is provided. The communication method may comprise: determining, by a terminal, to transmit first uplink control information and second uplink control information in a target time unit, if the terminal uses a first uplink control channel when individually transmitting the first uplink information in the target time unit, and if the terminal uses a second uplink control channel when individually transmitting the second uplink control information in the a target time unit, and a number of time domain symbols included in the first uplink control channel is greater than a number of time domain symbols included in the second uplink control channel; using, by the terminal, target time domain symbols in the first uplink control channel to transmit the second uplink control information in a target time unit, wherein the target time domain symbols are at least some time domain symbols from among the time domain symbols used for transmitting reference symbols (RS) in the first uplink control channel; using, by the terminal, time domain symbols, other than the time domain symbols used for transmitting reference symbols in the first uplink control channel, to transmit the first uplink control information in the target time unit.

The communication method may transmit both of the first uplink control information and the second uplink control information in the same time unit. Moreover, the second uplink control information is send by using the time domain symbols used for sending the reference symbols in the first uplink control channel, which may improve the utilization rate of resources.

In a possible implementation, before using, by the terminal, target time domain symbols in the first uplink control channel to transmit the second uplink control information in a target time unit, the communication method may further comprise at least one of the following steps: determining, by the terminal, that the number of time domain symbols in the second uplink control channel is not greater than the number of time domain symbols used for transmitting the reference symbols in the first uplink control channel; determining, by the terminal, that the number of resource units for transmitting the second uplink control channel is not greater than the number of resource units used for transmitting the reference symbols in the first uplink control channel; determining, by the terminal, that a frequency domain bandwidth used for transmitting the second uplink control channel is not greater than the frequency domain bandwidth used for transmitting the first uplink control channel.

In this implementation, the terminal may use the time domain symbols, which were originally used for transmitting the reference symbols in the first uplink control channel, to transmit the second uplink control information, when it is determined that the second uplink control channel, which was originally used for transmitting the second uplink control information, satisfies specific conditions, thereby guaranteeing the reliability of communication.

In a possible implementation, before using, by the terminal, target time domain symbols in the first uplink control channel to transmit the second uplink control information in a target time unit, the communication method may further comprise: receiving, by the terminal, first configuration information transmitted by a network device, wherein the first configuration information is used for indicating that the terminal supports transmitting the first uplink control information and the second uplink information in a same time unit.

In this implementation, the terminal transmits, when instructed by the network device, both of the first uplink control information and the second uplink control information in the same uplink control channel of the same time unit, which may improve the reliability of communication.

In a possible implementation, before using, by the terminal, target time domain symbols in the first uplink control channel to transmit the second uplink control information in a target time unit, the communication method may further comprise: receiving, by the terminal, second configuration information transmitted by the network device, wherein the second configuration information is used for indicating that the terminal supports transmitting the second uplink control information by using the time domain symbols for transmitting the reference symbols.

In this implementation, the terminal transmits, when instructed by the network device, the second control channel information by using the time domain symbols used for transmitting reference symbols in the first uplink control channel, which may improve the reliability rate of communication.

In a possible implementation, a bandwidth of the target time domain symbols is not less than the bandwidth of other time domain symbols in the first uplink control channel.

In this implementation, the terminal transmits the second uplink control information by using the time domain symbols with large bandwidth in the first uplink control information, which may improve the reliability rate of communication.

In a possible implementation, using, by the terminal, target time domain symbols in the first uplink control channel to transmit the second uplink control information in a target time unit, may comprise: determining, by the terminal, according to a position of the time domain symbols used for transmitting the second uplink control channel, a position of at least some time domain symbols from among the time domain symbols used for transmitting reference symbols in the first uplink control channel.

In a possible implementation, the communication method may further comprise: receiving, by the terminal, third configuration information transmitted by the network device, wherein the third configuration information is used for indicating the position of at least some time domain symbols from among the time domain symbols used for transmitting reference symbols in the first uplink control channel.

In this implementation, the terminal transmits the second uplink control information by using at least some time domain symbols indicated by the network device from among the time domain symbols used for transmitting reference symbols in the first uplink control channel, which may improve the flexibility and reliability of communication.

In a possible implementation, using, by the terminal, target time domain symbols in the first uplink control channel to transmit the second uplink control information in a target time unit, may comprise: determining, by the terminal, according to the information carried in the second uplink control information, a sequence that is transmitted on the target domain symbols, wherein sequences corresponding to different information carried in the second uplink control information are different.

In a possible implementation, the terminal determining, according to the information carried in the second uplink control channel, the sequence that is transmitted on the target domain symbols, may comprise: when all the information carried by the second uplink control channel is negative acknowledgement (NACK), determining, by the terminal, to transmit a first sequence on the target domain symbol in the first uplink control channel, wherein the first sequence is a sequence that is transmitted on the target time domain symbols when the terminal individually transmits the first uplink control information by using the first uplink control channel.

This implementation may improve the reliability of communication.

In a possible implementation, the order number of the sequence is determined by the terminal according to the order number of the first uplink control channel.

According to a second aspect of the present disclosure, a communication method is provided. The communication method may comprising: receiving, by a network device, to receive first uplink control information and second uplink control information in a target time unit, if the terminal uses a first uplink control channel when individually transmitting the first uplink information in the target time unit, and if the terminal uses a second uplink control channel when individually transmitting the second uplink control information in the a target time unit, and a number of time domain symbols included in the first uplink control channel is greater than a number of time domain symbols included in the second uplink control channel; receiving, by the network device, in a target time unit, the second uplink control information on target time domain symbols in the first uplink control channel, wherein the target time domain symbols are at least some time domain symbols from among the time domain symbols used for transmitting reference symbols in the first uplink control channel; receiving by the network device, in the target time unit, the first uplink control information on the time domain symbols, other than the time domain symbols for transmitting reference symbols, in the first uplink control channel.

The communication method may transmit the first uplink control information and the second uplink control information in the same time unit. Moreover, the second uplink control information is send by using the time domain symbols used for sending the reference symbols in the first uplink control channel, which may improve the utilization rate of resources.

In a possible implementation, before the network device receiving, in a target time unit, the second uplink control information on the target time domain symbols in the first uplink control channel, the communication method may further comprise at least one of the following steps: determining by the network device, that the number of time domain symbols in the second uplink control channel is not greater than the number of time domain symbols used for transmitting the reference symbols in the first uplink control channel; determining by the network device, that the number of resource units for transmitting the second uplink control channel is not greater than the number of resource units used for transmitting the reference symbols in the first uplink control channel; determining, by the network device, that a frequency domain bandwidth used for transmitting the second uplink control channel is not greater than the frequency domain bandwidth used for transmitting the first uplink control channel.

In this implementation, the second uplink control information may be transmitted by using the time domain symbols that were originally used for transmitting the reference symbols in the first uplink control channel, when it is determined that the second uplink control channel that was originally used for transmitting the second uplink control information satisfies specific conditions, thereby guaranteeing the reliability of communication.

In a possible implementation, before the network device receiving, in a target time unit, the second uplink control information on the target time domain symbols in the first uplink control channel, the communication method may further comprise: transmitting, by the network device, first configuration information to a terminal, the first configuration information indicating that the terminal supports transmitting the first uplink control information and the second uplink information in a same time unit.

This implementation enables the terminal to transmit, when instructed by the network device, the first uplink control information and the second uplink control information in the same uplink control channel of the same time unit, which may improve the reliability of communication.

In a possible implementation, before the network device receiving, in a target time unit, the second uplink control information on the target time domain symbols in the first uplink control channel, the communication method may further comprises: transmitting, by the network device, second configuration information to the terminal, the second configuration information indicating that the terminal supports transmitting the second uplink control information by using the time domain symbols for transmitting the reference symbols.

This implementation enables the terminal to transmit, when instructed by the network device, the second control channel information by using the time domain symbols, used for transmitting reference symbols, in the first uplink control channel, which may improve the reliability rate of communication.

In a possible implementation, a bandwidth of the target time domain symbols is not less than the bandwidth of other time domain symbols in the first uplink control channel.

In this implementation, the terminal transmits the second uplink control information by using the time domain symbols with large bandwidth in the first uplink control information, which may improve the reliability rate of communication.

In a possible implementation, the network device receiving, in a target time unit, the second uplink control information on the target time domain symbols in the first uplink control channel, may comprise: determining, by the network device, according to a position of the time domain symbols used for transmitting the second uplink control channel, a position of at least some time domain symbols from among the time domain symbols used for transmitting reference symbols, in the first uplink control channel.

In a possible implementation, the communication method may further comprise: transmitting, by the network device, third configuration information to the terminal, the third configuration information indicating the position of at least some time domain symbols from among the time domain symbols used for transmitting reference symbols in the first uplink control channel.

In this implementation, the terminal transmits the second uplink control information by using at least some time domain symbols indicated by the network device from among the time domain symbols used for transmitting reference symbols in the first uplink control channel, which may improve the flexibility and reliability of communication.

In a possible implementation, the network device receiving, in a target time unit, the second uplink control information on the target time domain symbols in the first uplink control channel, may comprise: determining, by the network device, according to a sequence on the target domain symbols, the information carried in the second uplink control information, wherein sequences corresponding to different information carried in the second uplink control information are different.

In a possible implementation, the network device determining, according to a sequence on the target domain symbols, the information carried in the second uplink control information, may comprise: when the sequence on the target domain symbol is a first sequence, determining, by the network device, that all the information carried by the second uplink control channel is NACK, wherein the first sequence is a sequence that is transmitted on the target time domain symbols when the terminal individually transmits the first uplink control information by using the first uplink control channel. This implementation may improve the reliability of communication.

In a possible implementation, the order number of the sequence is determined by the terminal according to the order number of the first uplink control channel.

According to a third aspect of the present disclosure, a terminal is provided, wherein the terminal comprises a module used for executing a communication method of the first aspect or any of the possible implementations of the first aspect.

According to a fourth aspect of the present disclosure, a network device is provided, wherein the network device comprises a module used for executing a communication method of the second aspect or any of the possible implementations of the second aspect.

According to a fifth aspect of the present disclosure, a terminal is provided, comprising a processor and a transmitter, wherein the processor is used for execution code. When the code is executed, the processor and the transmitter implement the communication method of the first aspect or any of the possible implementations of the first aspect. Alternatively, the terminal may further comprise a receiver.

According to a sixth aspect of the present disclosure, a network device is provided, comprising a processor and a receiver, wherein the processor is used for execution code. When the code is executed, the processor and the receiver implement the communication method of the second aspect or any of the possible implementations of the second aspect. Alternatively, the terminal may further comprise a transmitter.

According to a seventh aspect of the present disclosure, a computer readable medium is provided, wherein the computer readable medium stores program code for the terminal execution. The program code comprises instructions used for executing the communication method of the first aspect or any of the possible implementations of the first aspect.

According to an eighth aspect of the present disclosure, a computer readable medium is provided, wherein the computer readable medium stores program code for the network device execution. The program code comprises instructions used for executing the communication method of the second aspect or any of the possible implementations of the second aspect.

According to a ninth aspect of the present disclosure, a computer program product is provided, including instructions. When the computer program product is running on the terminal, the terminal is enabled to execute the communication method of the first aspect or any of the possible implementations of the first aspect.

According to a tenth aspect of the present disclosure, a computer program product is provided, including instructions. When the computer program product is running on the network device, the network device is enabled to execute the communication method of the second aspect or any of the possible implementations of the second aspect.

### BRIEF DESCRIPTION OF THE DRAWINGS

FIG. 1 is an architecture diagram illustrating of the application scenario in an embodiment of the present disclosure;

FIG. 2 is a diagram illustrating of the application scenario of an embodiment of the present disclosure;

FIG. 3 is a flowchart diagram illustrating of the communication method of an embodiment of the present disclosure;

FIG. 4 is a diagram illustrating of the time unit in the communication method of an embodiment of the present disclosure;

FIG. 5 is a diagram illustrating of the time unit in the communication method of an embodiment of the present disclosure;

FIG. 6 is a flowchart diagram illustrating of the communication method in of embodiment of the present disclosure;

FIG. 7 is a structure diagram illustrating of the terminal of an embodiment of the present disclosure;

FIG. 8 is a structure diagram illustrating of the network device of an embodiment of the present disclosure;

FIG. 9 is a structure diagram illustrating of the terminal of an embodiment of the present disclosure;

FIG. 10 is a structure diagram illustrating of the network device of an embodiment of the present disclosure;

### DETAILED DESCRIPTION

An architecture diagram illustrating of an application scenario in which the communication method, the terminal, and the communication device of an embodiment of the present disclosure may be applied, as shown in FIG. 1. It should be understood that the embodiment of the present disclosure may not limited to the system architecture shown in FIG. 1. Moreover, the device in FIG. 1 may be hardware, or may be functionally divided software or a combination of the two.

As can be obtain from FIG. 1, the communication system, to which the communication method of the embodiment of the present disclosure may be applied, may include the terminal 120 and the communication device 130.

One example of the communication device 130 is a base station. It should be understood that the specific type of the base station is not limited in the embodiment of the present disclosure. In systems with different wireless access technologies, the names of devices with base station function may vary. For convenience of description, in all embodiments of the present disclosure, the above apparatus for providing a wireless communication function to the terminal is collectively referred to as a base station, such as a base station equipment in future network, a small base station equipment (pico), etc.

The terminal 120 may be user equipment (UE). The UE can communication with one or more core networks (CN) via a radio access network (RAN). The UE may be referred to as an access terminal, a terminal device, a subscriber unit, a subscriber station, a mobile station, a mobile carriage, a remote station, a remote terminal, a mobile device, a user terminal, a wireless communication device, a user agent, or a user device. The UE may be a cellular phone, a cordless phone, a session initiation protocol (SIP) phone, a wireless local loop (WLL) station, a personal digital assistant (PDA), a handheld device with wireless communication function, a computing device or other device connected to a wireless modem, an in-vehicle device, a wearable device or Internet of Things, a terminal device in a vehicle network, and any form of terminal device in a future network.

Communication between the terminal 120 and the network device 130 is possible. For example, the network 130 may transmit downlink service data to the terminal 120, and the terminal 120 may feedback the receiving status of the downlink service data to the network device 130. For example, the terminal 120 may send an acknowledgement (ACK) information to the network device 130, indicating that the terminal 120 correctly receives the downlink service data, and for example, the terminal 120 may send a negative acknowledgement (NACK) information to the network device 130, indicating that the terminal 120 does not receive the downlink service data or erroneously receives the downlink service data. Wherein, the ACK information and the NACK information may be referred to as uplink control information.

Specifically, the terminal 120 may send the uplink control information to the network device 130 by a PUCCH. Wherein, the terminal 120 may send the uplink control information to the network device 130 by PUCCHs with two lengths which may be called long-PUCCH and short-PUCCH, respectively. The long-PUCCH may include at least 4 time domain symbols, and the short-PUCCH may include 1 or 2 time domain symbols.

When the terminal 120 communicates with the network device 130, the feedback delays of different downlink service data sent by the network device 130 to the terminal 120 may be different. The feedback information of different feedback delays may be transmitted by PUCCHs with different lengths.

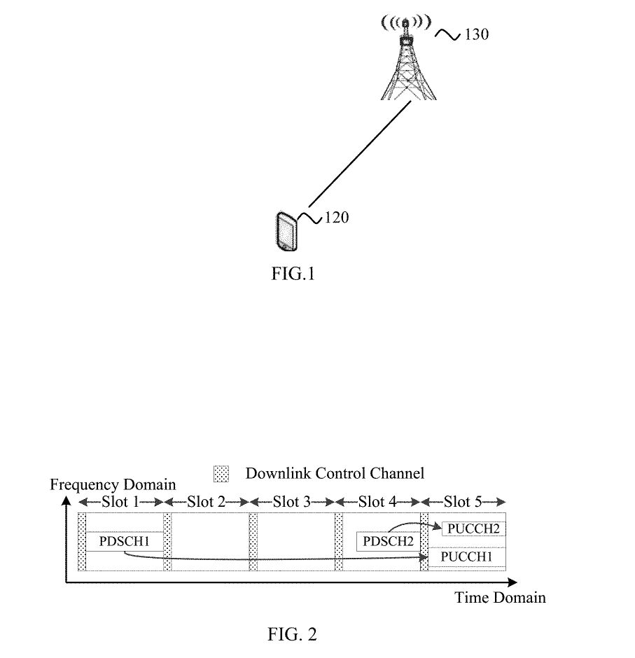

As shown in FIG. 2, the network device 130 transmits a physic downlink data channel (PDSCH) 1 to the terminal 120 in a slot 1. The feedback delay of the PDSCH 1 is 4 slots. The terminal may send the feedback information (which may be referred to as first uplink control information) of the PDSCH 1 by the PUCCH 1 (which may be referred to as a first uplink control channel). The network device 130 transmits a PDSCH 2 to the terminal 120 in a slot 4. The feedback delay of the PDSCH 2 is 1 slot. The terminal may send the feedback information (which may be referred to as second uplink control information) of the PDSCH 2 by the PUCCH 2 (which may be referred to as a second uplink control channel).

Further, as can been obtain from FIG. 2, the feedback time of the PDSCH 1 and the feedback time of the PDSCH 2 are both located in slot 5. That is, the PUCCH 1 configured by the terminal 130 for the feedback information of the PDSCH 1 is located in the same slot as the PUCCH 2 configured by the terminal 130 for the feedback information of the PDSCH 2.

However, in the current communication system or communication method, a method of how to transmit PUCCHs of different lengths in the same time unit has not been proposed.

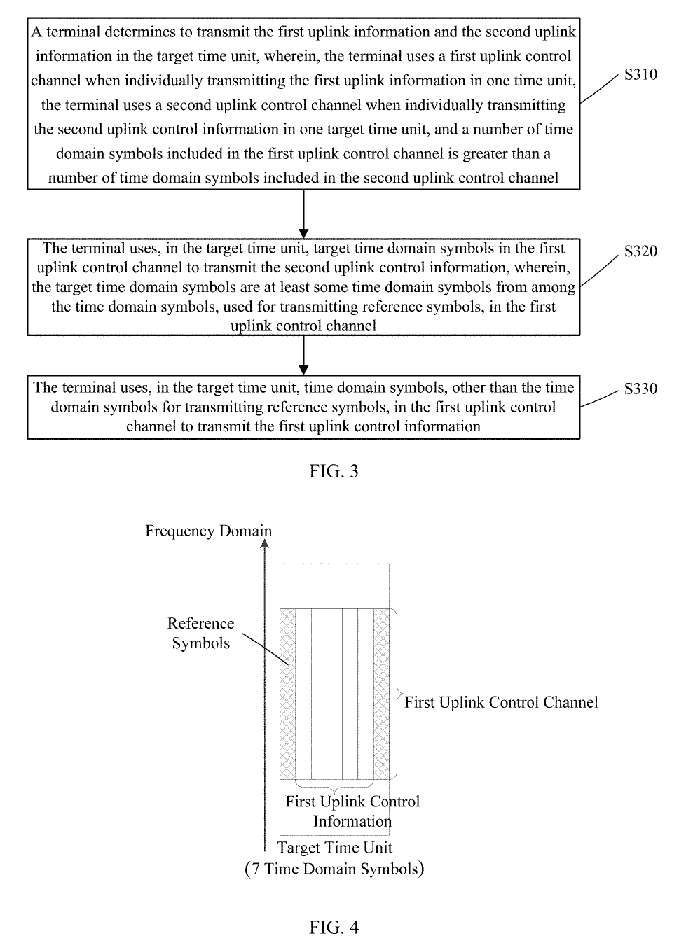

FIG. 3 is a flowchart diagram illustrating of the communication method in one embodiment of the present disclosure. It should understood that FIG. 3 shows the steps or operations of the communication method, but these steps or operations are merely examples, and the embodiments of the present disclosure may also execute other operations or variations of the operations in FIG. 3. Moreover, the various steps in FIG. 3 may be executed in a different order than that present in FIG. 3, and it is possible that not all operations in FIG. 3 are to be executed.

In S310, the terminal determines to transmit the first uplink information and the second uplink information in the target time unit.

Wherein, the terminal uses a first uplink control channel when individually transmitting the first uplink information in one time unit, the terminal uses a second uplink control channel when individually transmitting the second uplink control information in one target time unit, and a number of time domain symbols included in the first uplink control channel is greater than a number of time domain symbols included in the second uplink control channel.

The first uplink control information may be used for feedback the receiving state of the terminal on receiving one or more first downlink data channels (such as a long physical downlink shared channel). The second uplink control information may be used for feedback the receiving state of the terminal on receiving one or more second downlink data channels (such as a short physical downlink shared channel).

In S310, the first uplink control channel used by the terminal when individually transmitting the first uplink information in one time unit refers to a channel for transmitting the first uplink control information in the time unit when the terminal determines that only the first uplink control information needs to be sent in a certain time unit, and does not need to send the second uplink control information. the second uplink control channel used by the terminal when individually transmitting the second uplink information in the target time unit refers to a channel for transmitting the second uplink control information in the time unit when the terminal determines that only the second uplink control information needs to be sent in a certain time unit, and does not need to send the first uplink control information.

Wherein, when the terminal sends information by using the first uplink control channel and the second uplink control channel separately, the number of time domain symbols occupied by the first uplink control channel is different from the number of time domain symbols occupied by the second uplink control channel. Specifically, the number of the time domain symbols occupied by the first uplink control channel may be greater than the number of time domain symbols occupied by the second uplink control channel.

For the convenience of subsequent description, in this embodiment of the present disclosure, when the terminal sends information by using the first uplink control channel and the second uplink control channel separately, the number of the time domain symbols occupied by the first uplink control channel is referred to as the number of first time domain symbols, and the number of the time domain symbols occupied by the second uplink control channel is referred to as the number of second time domain symbols.

In S310, the terminal determining to transmit the first uplink control information and the second uplink control information in the target time unit, may comprise that the terminal determines that the first uplink control information need to be sent in the target time unit, and determines that the second uplink control information need to be sent in the target time unit. Wherein, the target time unit may be a slot, or may be a sub-frame, or other time unit.

In S320, The terminal transmits the second uplink control information by using the target time domain symbols in the first uplink control channel in target time unit.

Wherein, the target time domain symbols are at least some time domain symbols from among the time domain symbols, used for transmitting reference symbols, in the first uplink control channel.

Wherein, the time domain symbols used for transmitting the reference symbols in the first uplink control channel, refers to time domain symbols which may be used to send reference symbols when the first uplink control channel does not send the second uplink control information. In other words, in this time unit, when the second uplink control information is to be sent, the target time domain symbols in the first uplink control channel is used to send the second uplink control information, and when there is no second uplink control to be sent, the target time domain symbols in the first uplink control channel may be used to send the reference symbols.

The target time domain symbol is all or part of the time domain symbols used to transmit the reference symbols in the first uplink control channel.

It can be known from the above that the terminal may use the time domain symbols used for sending the reference symbols among the time domain symbols occupied by the first uplink control channel to send the second uplink control information, which may not only implement the purpose of sending the second uplink control information, but also make full use of resources to provide resource utilization.

In S330, the terminal uses time domain symbols, other than the time domain symbols for transmitting reference symbols, in the first uplink control channel to transmit the first uplink control information in the target time unit.

In other words, when the terminal sends the second uplink control information by using the target time domain symbols in the first uplink control channel in target time unit, the terminal may further send the first uplink control information by suing the time domain symbols other than those originally used for transmitting the reference symbols in the first uplink control channel, so that the first uplink control information and the second uplink control information may be transmitted in the same uplink control channel of the same time unit.

In the communication method of the embodiment of the present disclosure, optionally, before the terminal using the target time domain symbols in the first uplink control channel to transmit the second uplink control information in the target time unit, the communication method further comprises at least one of the following steps. The terminal determines that the number of time domain symbols in the second uplink control channel is not greater than the number of time domain symbols, used for transmitting the reference symbols, in the first uplink control channel. The terminal determines that the number of resource units for transmitting the second uplink control channel is not greater than the number of resource units used for transmitting the reference symbols in the first uplink control channel. The terminal determines that a frequency domain bandwidth used for transmitting the second uplink control channel is not greater than the frequency domain bandwidth used for transmitting the first uplink control channel.

In other words, the terminal may use all or part of the time domain symbols, used for transmitting the reference symbols in the first uplink control channel, to transmit the second uplink control information, when it is determined that the second uplink control channel, originally used for transmitting the second uplink control information, satisfies at least one of the above conditions, thereby guaranteeing the reliability of communication.

In the communication method of the embodiment of the present disclosure, optionally, before the terminal using the target time domain symbols in the first uplink control channel to transmit the second uplink control information in the target time unit, the communication method further comprises that the terminal receives first configuration information transmitted by a network device, wherein the first configuration information indicates that the terminal supports transmitting the first uplink control information and the second uplink information in a same time unit.

In other words, the terminal transmits, when instructed by the network device, the second uplink control information and the first uplink control information in the same uplink control channel of the same time unit, thereby improving the reliability of communication.

In the communication method of the embodiment of the present disclosure, optionally, before the terminal using the target time domain symbols in the first uplink control channel to transmit the second uplink control information in the target time unit, the communication method further comprises that the terminal receiving second configuration information transmitted by the network device, wherein the second configuration information indicates that the terminal supports transmitting the second uplink control information by using the time domain symbols for transmitting the reference symbols.

In other words, the terminal transmits, when instructed by the network device, the first control channel information by using the time domain symbols, used for transmitting reference symbols, in the first uplink control channel, thereby improving the reliability rate of communication.

In the communication method of the embodiment of the present disclosure, optionally, a bandwidth of the target time domain symbols is not less than the bandwidth of other time domain symbols in the first uplink control channel. In other words, the terminal transmits the second uplink control information by using the time domain symbols with large bandwidth among the time domain symbols used for transmitting the reference symbols in the first uplink control information, which may further improve the reliability rate of communication.

In the communication method of the embodiment of the present disclosure, optionally, the terminal using, the target time domain symbols in the first uplink control channel to transmit the second uplink control information in the target time unit, may comprise that the terminal determines, according to a position of the time domain symbols used for transmitting the second uplink control channel, a position of at least some time domain symbols from among the time domain symbols, used for transmitting reference symbols, in the first uplink control channel.

In other words, the terminal determines, according to the position of the time domain symbols in the second uplink control channel that may be used when the second uplink control information is individually transmitted, which of the time domain symbols of the first uplink control channel that are originally used to send the reference symbols is the target time domain symbols for sending the second uplink control information.

In the communication method of the embodiment of the present disclosure, optionally, it may further comprise that the terminal receiving third configuration information transmitted by the network device, wherein the third configuration information indicates the position of at least some time domain symbols from among the time domain symbols, used for transmitting reference symbols, in the first uplink control channel.

In other words, the terminal may determine, according to the indication of the network devices, which of the time domain symbols of the first uplink control channel that are originally used to send the reference symbols is the target time domain symbols for sending the second uplink control information. This not only improves the reliability of communication, but also improves the flexibility of communication.

In the communication method of the embodiment of the present disclosure, optionally, the terminal using the target time domain symbols in the first uplink control channel to transmit the second uplink control information in the target time unit, may comprise that the terminal determines, according to the information carried in the second uplink control information, a sequence that is transmitted on the target domain symbols, wherein sequences corresponding to different information carried in the second uplink control carrying information are different.

Usually, the network device may indicate that the terminal transmits the second uplink control information by suing the time domain symbols located at the end of the target time domain unit among the time domain symbols originally used for transmitting the reference symbols in the first uplink control channel.

In other words, when the information carried in the second uplink control information is different, the sequence on the target time domain symbols is different. In other words, the terminal may pre-configure the correspondence between the different content of the second uplink control information and the different sequence, and then the terminal may determine the sequence transmitted on the target time domain symbols according to the information carried by the second uplink control information. If the target time domain symbols are multiple, the target time domain symbols correspond to the sequence group.

In the communication method of the embodiment of the present disclosure, optionally, the terminal determining, according to the information carried in the second uplink control information, a sequence that is transmitted on the target domain symbols, may comprise that when the information carried by the second uplink control channel is all NACK, the terminal determines to transmit a first sequence on the target domain symbol in the first uplink control channel, wherein the first sequence is a sequence that is transmitted on the target time domain symbols when the terminal individually transmits the first uplink control information by using the first uplink control channel.

In other words, when the information of the second uplink control information pre-configured on the terminal is all NACK, the sequence corresponding to the target time domain symbols is the first sequence or the first sequence group when the target time domain symbols is used for transmitting the reference symbols. The first sequence or the first sequence group is a sequence that should be transmitted on the time domain symbols, when the time domain symbols originally used for transmitting the reference symbols in the first uplink control channel are actually used for transmitting the reference symbols.

In this way, under the circumstances that the network device sends the first downlink data channel and the second downlink data channel, even if the terminal loses the second downlink data channel, when the terminal only sends the first uplink control information by using the first uplink control information according to the method for transmitting the first uplink control information separately, the network device also can obtain that the terminal does not receive the information of the second downlink data channel according to the first sequence or the first sequence group on the target time domain symbols.

Optionally, if the second uplink control information carries 1 bit of ACK or NACK information, the target time domain symbols for transmitting the ACK may correspond to the second sequence of the second sequence group, and the target time domain symbols for transmitting the NACK may correspond to the first sequence of the first sequence group.

If the second uplink control information carries 2 bits of NACK and ACK information, the target time domain symbols may correspond to the third sequence of the third sequence group.

If the second uplink control information carries 2 bits of ACK and NACK information, the target time domain symbols may correspond to the fourth sequence of the fourth sequence group.

If the second uplink control information carries 2 bits of ACK and ACK information, the target time domain symbols may correspond to the fifth sequence of the fifth sequence group.

In the communication method of the embodiment of the present disclosure, optionally, each sequence has a number, and the sequence number may be configured by the terminal according to the resource number of the first uplink control channel.

Specifically, the terminal may configure the number of the first sequence or the first sequence group according to the resource number of the first uplink control channel, and the terminal may configure numbers of other sequences according to the number of the first sequence or the first sequence group and agreed offset value.

In this way, when the terminal sends the second uplink control information by using the target time domain symbols, the sequence transmitted on the target time domain symbols may be determined according to the content of the second uplink control information. Then, according to the order number of the sequence and the numbered correspondence corresponding to the above configuration, the resource number for transmitting the target time domain symbols may be determined, thereby determining the resource for transmitting the target time domain symbols.

As shown in FIG. 4, when the terminal individually transmits the first uplink control information in the target time unit, the first uplink control channel is used. The first uplink control channel occupied 7 time domain symbols, wherein, the reference symbols are transmitted on the first time domain symbol and the last time domain symbol, and the first uplink control information is transmitted on the second to sixth time domain symbols.

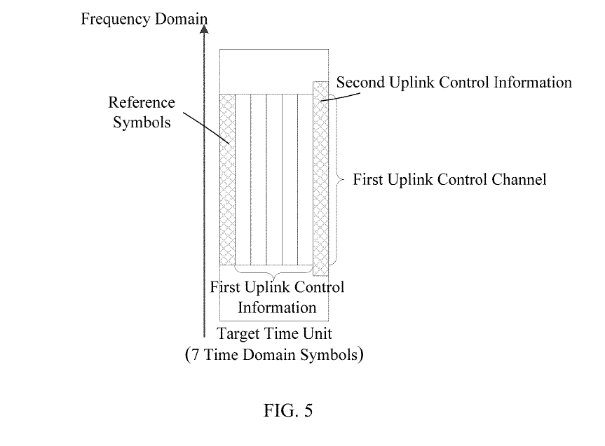

As shown in FIG. 5, when the terminal transmits the first uplink control information and the second uplink control information by using the first uplink control channel in the target time unit, the terminal transmits the second uplink control information on the time domain symbols at the end of the two symbols originally used for transmitting the reference symbols, and transmits the first uplink control information on the second to sixth time domain symbols.

FIG. 6 is a flowchart diagram illustrating of the communication method in one embodiment of the present disclosure. It should be understood that FIG. 6 shows the steps or operations of the communication method, but these steps or operations are merely examples, and the embodiments of the present disclosure may also execute other operations or variations of the operations in FIG. 6. Moreover, the various steps in FIG. 6 may be executed in a different order than that present in FIG. 6, and it is possible that not all operations in FIG. 6 are to be executed.

In S610, the network device determines to receive the first uplink information and the second uplink information in the target time unit.

Wherein, the terminal uses a first uplink control channel when individually transmitting the first uplink information in the target time unit, the terminal uses a second uplink control channel when individually transmitting the second uplink control information in the a target time unit, and a number of time domain symbols included in the first uplink control channel is greater than a number of time domain symbols included in the second uplink control channel.

In S620, the network device receives, in a target time unit, the second uplink control information on target time domain symbols in the first uplink control channel, wherein the target time domain symbols are at least some time domain symbols from among the time domain symbols, used for transmitting reference symbols, in the first uplink control channel.

In S630, the network device receives, in the target time unit, the first uplink control information on the time domain symbols, other than the time domain symbols for transmitting reference symbols, in the first uplink control channel.

The communication method may transmit the first uplink control information and the second uplink control information in the same time unit. Moreover, the second uplink control information is send by using the time domain symbols used for sending the reference symbols in the first uplink control channel, which may improve the utilization rate of resources.

In the communication method of the embodiment of the present disclosure, optionally, before the network device receiving the second uplink control information on the target time domain symbols in the first uplink control channel in a target time unit, the communication method may further comprise at least one of the following steps. The network device determines that the number of time domain symbols in the second uplink control channel is not greater than the number of time domain symbols, used for transmitting the reference symbols, in the first uplink control channel. The network device determines that the number of resource units for transmitting the second uplink control channel is not greater than the number of resource units used for transmitting the reference symbols in the first uplink control channel. The network device determines that a frequency domain bandwidth used for transmitting the second uplink control channel is not greater than the frequency domain bandwidth used for transmitting the first uplink control channel.

In the communication method of the embodiment of the present disclosure, optionally, before the network device receiving the second uplink control information on the target time domain symbols in the first uplink control channel in a target time unit, the communication method may further comprise that the network device transmits first configuration information to a terminal, wherein the first configuration information is used for indicating that the terminal supports transmitting the first uplink control information and the second uplink information in a same time unit.

In the communication method of the embodiment of the present disclosure, optionally, before the network device receiving the second uplink control information on the target time domain symbols in the first uplink control channel in a target time unit, the communication method may further comprise that the network device transmits second configuration information to the terminal, wherein the second configuration information is used for indicating that the terminal supports transmitting the second uplink control information by using the time domain symbols for transmitting the reference symbols.

In the communication method of the embodiment of the present disclosure, optionally, a bandwidth of the target time domain symbols is not less than the bandwidth of other time domain symbols in the first uplink control channel.

In the communication method of the embodiment of the present disclosure, optionally, the network device receiving the second uplink control information on the target time domain symbols in the first uplink control channel in a target time unit, may comprise that the network device determines, according to a position of the time domain symbols used for transmitting the second uplink control channel, a position of at least some time domain symbols from among the time domain symbols, used for transmitting reference symbols, in the first uplink control channel.

In the communication method of the embodiment of the present disclosure, optionally, the communication method may further comprise that the network device transmits third configuration information to the terminal, wherein the third configuration information is used for indicating the position of at least some time domain symbols from among the time domain symbols, used for transmitting reference symbols, in the first uplink control channel.

In the communication method of the embodiment of the present disclosure, optionally, the network device receiving the second uplink control information on the target time domain symbols in the first uplink control channel in a target time unit, may comprise that the network device determines, according to a sequence on the target domain symbols, the information carried in the second uplink control information, wherein sequences corresponding to different information carried in the second uplink control information are different.

In the communication method of the embodiment of the present disclosure, optionally, the network device determining, according to a sequence on the target domain symbols, the information carried in the second uplink control information, may comprise that when the sequence on the target domain symbol is a first sequence, the network device determines that the information carried by the second uplink control channel is all NACK, wherein the first sequence is a sequence that is transmitted on the target time domain symbols when the terminal individually transmits the first uplink control information by using the first uplink control channel. This implementation may improve the reliability of communication.

In the communication method of the embodiment of the present disclosure, optionally, the order number of the sequence is determined by the terminal according to the order number of the first uplink control channel.

It should be understood that, the network device in the communication method shown in FIG. 6 may be the network device in the communication method shown in FIG. 3. That is, the technical features of the network device in the communication method shown in FIG. 3 are also applicable to the network device in the communication method shown in FIG. 6. For the sake of brevity, it will not be repeated here.

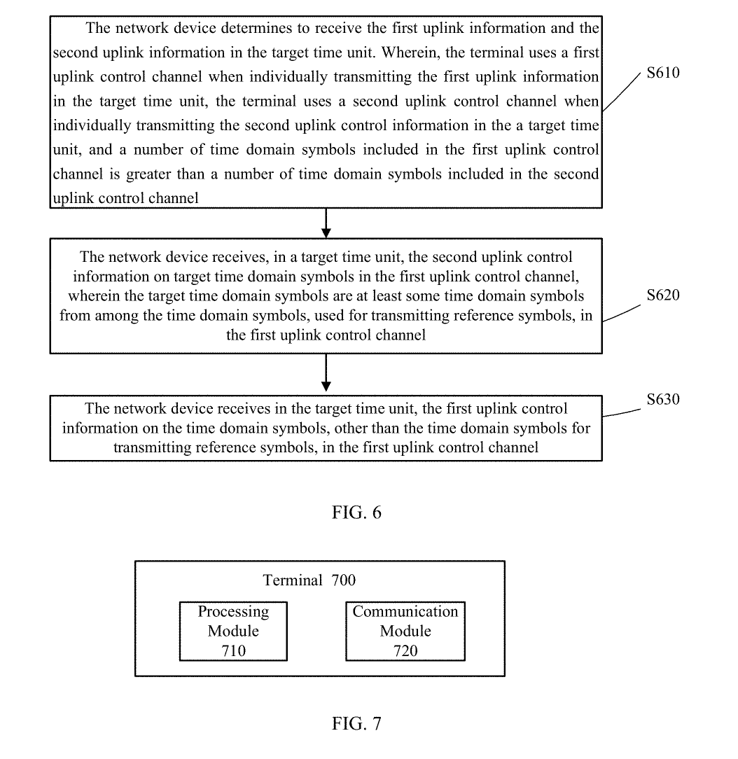

FIG. 7 is a structure diagram illustrating of the terminal of one embodiment of the present disclosure. It should be understood that the terminal 700 shown in FIG. 7 is only an example, and the terminal in the embodiment of the present disclosure may further include other modules or units, or include modules similar in function to the various modules in FIG. 7, or not all the modules in FIG. 7 are included.

A processing module 710 is configured to determine the transmission of first uplink control information and second uplink control information in a target time unit, wherein the terminal uses a first uplink control channel when individually transmitting the first uplink information in the target time unit, the terminal uses a second uplink control channel when individually transmitting the second uplink control information in the a target time unit, and a number of time domain symbols included in the first uplink control channel is greater than a number of time domain symbols included in the second uplink control channel.

A communication module 720 is configured to transmit, in a target time unit, the second uplink control information by using target time domain symbols in the first uplink control channel, wherein the target time domain symbols are at least some time domain symbols from among the time domain symbols, used for transmitting reference symbols, in the first uplink control channel;

Wherein the communication module 720 is further configured to transmit, in the target time unit, the first uplink control information by using time domain symbols, other than the time domain symbols for transmitting reference symbols, in the first uplink control channel.

The terminal may transmit the first uplink control information and the second uplink control information in the same time unit. Moreover, the second uplink control information is send by using the time domain symbols used for sending the reference symbols in the first uplink control channel, which may improve the utilization rate of resources.

Optionally, the communication module transmitting, in the target time unit, the second uplink control information by using target time domain symbols in the first uplink control channel, the processing module is further configured to perform at least one of the following steps: determining that the number of time domain symbols in the second uplink control channel is not greater than the number of time domain symbols, used for transmitting the reference symbols, in the first uplink control channel; determining that the number of resource units for transmitting the second uplink control channel is not greater than the number of resource units used for transmitting the reference symbols in the first uplink control channel; determining that a frequency domain bandwidth used for transmitting the second uplink control channel is not greater than the frequency domain bandwidth used for transmitting the first uplink control channel.

Optionally, before the communication module transmitting, in the target time unit, the second uplink control information by using target time domain symbols in the first uplink control channel, the communication module is further configured to receive first configuration information transmitted by a network device, wherein the first configuration information is used for indicating that the terminal supports transmitting the first uplink control information and the second uplink information in a same time unit.

Optionally, before the communication module transmitting, in the target time unit, the second uplink control information by using target time domain symbols in the first uplink control channel, the communication module is further configured to receive second configuration information transmitted by the network device, and the second configuration information indicates that the terminal supports transmitting the second uplink control information by using the time domain symbols for transmitting the reference symbols.

Optionally, a bandwidth of the target time domain symbols is not less than the bandwidth of other time domain symbols in the first uplink control channel.

Optionally, the communication module is specifically configured to determine, according to a position of the time domain symbols used for transmitting the second uplink control channel, a position of at least some time domain symbols from among the time domain symbols, used for transmitting reference symbols, in the first uplink control channel.

Optionally, the communication module is further configured to receive third configuration information transmitted by the network device, wherein the third configuration information indicates the position of at least some time domain symbols from among the time domain symbols, used for transmitting reference symbols, in the first uplink control channel.

Optionally, the communication module is specifically configured to determine, according to the information carried in the second uplink control information, a sequence that is transmitted on the target domain symbols, wherein sequences corresponding to different information carried in the second uplink control information are different.

Optionally, the communication module is specifically configured to determine, when the information carried by the second uplink control channel is all NACK, the transmission of a first sequence on the target domain symbol in the first uplink control channel, wherein the first sequence is a sequence that is transmitted on the target time domain symbols when the terminal individually transmits the first uplink control information by using the first uplink control channel.

Optionally, the order number of the sequence is determined by the terminal according to the order number of the first uplink control channel.

It should be understood that, the foregoing and other operations and/or functions of the various units of the terminal in the embodiment of the present disclosure units are shown in FIG. 7 for implementing the corresponding flow of the communication method in FIG. 4. For the sake of brevity, it will not be repeated here.

FIG. 8 is a structure diagram illustrating of the network device of an embodiment of the present disclosure. It should understood that that the network device 800 shown in FIG. 8 is only an example, and the network device in the embodiment of the present disclosure may further include other modules or units, or include modules similar in function to the various modules in FIG. 8, or not all the modules in FIG. 8 are included.

A processing module 810 is configured to determine the transmission of first uplink control information and second uplink control information in a target time unit, wherein a terminal uses a first uplink control channel when individually transmitting the first uplink information in the target time unit, the terminal uses a second uplink control channel when individually transmitting the second uplink control information in the a target time unit, and a number of time domain symbols included in the first uplink control channel is greater than a number of time domain symbols included in the second uplink control channel.

A communication module 820 is configured to receive, in a target time unit, the second uplink control information on target time domain symbols in the first uplink control channel, wherein the target time domain symbols are at least some time domain symbols from among the time domain symbols, used for transmitting reference symbols, in the first uplink control channel.

The communication module 820 is further configured to receive, in the target time unit, the first uplink control information on time domain symbols, other than the time domain symbols for transmitting reference symbols, in the first uplink control channel.

The network device may transmit the first uplink control information and the second uplink control information in the same time unit. Moreover, the second uplink control information is send by using the time domain symbols used for sending the reference symbols in the first uplink control channel, which may improve the utilization rate of resources.

Optionally, before the communication module receiving, in the target time unit, the second uplink control information on the target time domain symbols in the first uplink control channel, the processing module is further configured to perform at least one of the following steps: determining that the number of time domain symbols in the second uplink control channel is not greater than the number of time domain symbols, used for transmitting the reference symbols, in the first uplink control channel; determining that the number of resource units for transmitting the second uplink control channel is not greater than the number of resource units used for transmitting the reference symbols in the first uplink control channel; determining that a frequency domain bandwidth used for transmitting the second uplink control channel is not greater than the frequency domain bandwidth used for transmitting the first uplink control channel.

Optionally, before the communication module receiving, in the target time unit, the second uplink control information on the target time domain symbols in the first uplink control channel, the communication module is further configured to transmit first configuration information to the terminal, wherein the first configuration information indicates that the terminal supports transmitting the first uplink control information and the second uplink information in a same time unit.

Optionally, before the communication module receiving, in the target time unit, the second uplink control information on the target time domain symbols in the first uplink control channel, the communication module is further configured to transmit second configuration information to the terminal, wherein the second configuration information indicates that the terminal supports transmitting the second uplink control information by using the time domain symbols for transmitting the reference symbols.

Optionally, a bandwidth of the target time domain symbols is not less than the bandwidth of other time domain symbols in the first uplink control channel.

Optionally, the communication module is specifically configured to determine, according to a position of the time domain symbols used for transmitting the second uplink control channel, a position of at least some time domain symbols from among the time domain symbols, used for transmitting reference symbols, in the first uplink control channel.

Optionally, the communication module is further configured to transmit third configuration information to the terminal, wherein the third configuration information is used for indicating the position of at least some time domain symbols from among the time domain symbols, used for transmitting reference symbols, in the first uplink control channel.

Optionally, the communication module is specifically configured to determine, according to a sequence on the target domain symbols, the information carried in the second uplink control information, wherein sequences corresponding to different information carried in the second uplink control information are different.

Optionally, the communication module is specifically configured to determine, when the sequence on the target domain symbol is a first sequence, the information carried by the second uplink control channel is all NACK, wherein the first sequence is a sequence that is transmitted on the target time domain symbols when the terminal individually transmits the first uplink control information by using the first uplink control channel.

Optionally, the order number of the sequence is determined by the terminal according to the order number of the first uplink control channel.

It should be understood that, the foregoing and other operations and/or functions of the various units of the network device in the embodiment of the present disclosure units are shown in FIG. 8 for implementing the corresponding flow of the communication method in FIG. 6. For the sake of brevity, it will not be repeated here.

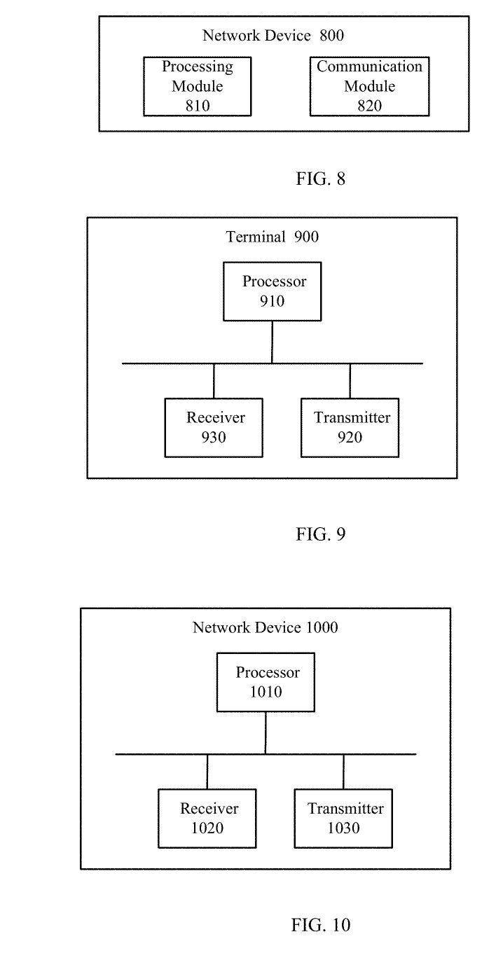

FIG. 9 is a structure diagram illustrating of the terminal of an embodiment of the present disclosure. It should understood that that the terminal 900 shown in FIG. 9 is only an example, and the terminal in the embodiment of the present disclosure may further include other modules or units, or include modules similar in function to the various modules in FIG. 9, or not all the modules in FIG. 9 are included.

Wherein, the processor 910 may be used for implementing the operations or the steps that the processing module 710 in FIG. 7 may implement. The transmitter 920 may be used for implementing partial operations or steps that the communication module 720 in FIG. 7 may implement. The receiver 930 may be used for implementing g partial operations or steps that the communication module 720 in FIG. 7 may implement. For the sake of brevity, it will not be repeated here.

FIG. 10 is a structure diagram illustrating of the network device of an embodiment of the present disclosure. It should be understood that the network device 1000 shown in FIG. 10 is only an example, and the network device in the embodiment of the present disclosure may further include other modules or units, or include modules similar in function to the various modules in FIG. 10, or not all the modules in FIG. 10 are included.

Wherein, the processor 1010 may be used for implementing the operations or the steps that the processing module 810 in FIG. 8 may implement. The receiver 1020 may be used for implementing partial operations or steps that the communication module 820 in FIG. 8 may implement. The transmitter 1030 may be used for implementing partial operations or steps that the communication module 820 in FIG. 8 may implement. For the sake of brevity, it will not be repeated here.

Those ordinary skilled in the art should be appreciated that, the units and algorithm steps described in conjunction with the embodiments disclosed by the present disclosure can be implemented in electronic hardware, computer software or a combination of computer software and electronic hardware. Whether these functions are to be performed in the form of hardware or software is depending on specific applications and constraint conditions for design of the technical solutions. Those ordinary skilled in the art can use different method for each of the specific applications so as to achieve the described functions, but such implementation should not be considered as going beyond the scope of the present disclosure.

Those skilled pertaining to the art will be clearly appreciated that, in order for convenience and concision of explanation, particular working processes of the system(s), device(s) and unit(s) described above can be referred to corresponding processes in the foregoing embodiments of the transmission method without repeating herein.

In several embodiments provided by the present disclosure, it should be understood that, the revealed system(s), device(s) and method(s) can be implemented in other ways. For example, the foregoing embodiments of the transmission method are merely illustrative. For example, the partition of the units merely is a partition in terms of logic functions, and there can be other partitions in practical implementation. For example, multiple units or components can be combined or integrated into another system, or some features can be omitted or may not be performed. Furthermore, the terms “coupling”, “direct coupling” or “communication connection” as revealed or discussed between objects can be indirect coupling or communication connection through several ports, devices or units, and can also be electric connection, mechanic connection or other forms of connection.

The units described as separate parts may or may not be separated physically. The part present as a unit may or may not be a physical unit, that is, it can be located in a single position or can be distributed in multiple network units. Part or all of the units can be selected according to actual demands, so as to achieve the objective of the technical solutions of the present disclosure.

Furthermore, the functional units in the embodiments of the present disclosure can be integrated in a single processing unit, and can also be present separately and physically, and can also be the case where two or more than two units are integrated in one unit.

The function, when implemented in a form of software functional unit and marketed or used as an independent product, can be stored in a computer-readable storage medium. Based on such understanding, the essence of the technical solutions of the present disclosure or a part of the technical solutions contributing to the existing technology, or all of or part of the technical solutions can be embodied in a form of software product. The software product is stored in a storage medium, including several instructions to cause a computer device (the computer device can be a personal computer, a server or a network device) to perform all or part of the steps of the transmission method described in the embodiments of the present disclosure. Furthermore, the foregoing storage medium includes various types of mediums which can store program codes, for example, USB flash disk, mobile Hard Disk Drive (HDD), Read-Only Memory (ROM), Random Access Memory (RAM), magnetic disk, optical disk and the like.

The above are merely specific implementations of the present disclosure without limiting the protection scope of the present disclosure thereto. Within the technical scope revealed in the present disclosure, modification(s) or substitution(s) may be easily conceivable for those skilled who are familiar with the present technical field, and these modification(s) and substitution(s) all should be contained in the protection scope of the present disclosure. Therefore the protection scope of the present disclosure should be based on the protection scope of the appended claims.

1. A communication method, comprising:
determining, by a terminal, to transmit first uplink control information and second uplink control information in a target time unit, if the terminal uses a first uplink control channel when individually transmitting the first uplink information in the target time unit, and if the terminal uses a second uplink control channel when individually transmitting the second uplink control information in the a target time unit, and a number of time domain symbols included in the first uplink control channel is greater than a number of time domain symbols included in the second uplink control channel;
using, by the terminal, target time domain symbols in the first uplink control channel to transmit the second uplink control information in a target time unit, wherein the target time domain symbols are at least some time domain symbols from among the time domain symbols used for transmitting reference symbols in the first uplink control channel;
using, by the terminal, time domain symbols, other than the time domain symbols for transmitting reference symbols in the first uplink control channel to transmit the first uplink control information in the target time unit.

2. The communication method according to claim 1, wherein before using, by the terminal, target time domain symbols in the first uplink control channel to transmit the second uplink control information in a target time unit, the communication method further comprises at least one of the following steps:
determining, by the terminal, that the number of time domain symbols in the second uplink control channel is not greater than the number of time domain symbols used for transmitting the reference symbols in the first uplink control channel;
determining, by the terminal, that the number of resource units for transmitting the second uplink control channel is not greater than the number of resource units used for transmitting the reference symbols in the first uplink control channel;
determining, by the terminal, that a frequency domain bandwidth used for transmitting the second uplink control channel is not greater than the frequency domain bandwidth used for transmitting the first uplink control channel.

3. The communication method according to claim 1, wherein before using, by the terminal, target time domain symbols in the first uplink control channel to transmit the second uplink control information in a target time unit, the communication method further comprises:
receiving, the terminal, first configuration information transmitted by a network device, wherein the first configuration information is used for indicating that the terminal supports transmitting the first uplink control information and the second uplink information in a same time unit.

4. The communication method according to claim 1, wherein before using, by the terminal, target time domain symbols in the first uplink control channel to transmit the second uplink control information in a target time unit, the communication method further comprises:
receiving, the terminal, second configuration information transmitted by the network device, wherein the second configuration information is used for indicating that the terminal supports transmitting the second uplink control information by using the time domain symbols for transmitting the reference symbols.

5. The communication method according to claim 1, wherein a bandwidth of the target time domain symbols is not less than the bandwidth of other time domain symbols in the first uplink control channel.

6. The communication method according to claim 1, wherein using, by the terminal, target time domain symbols in the first uplink control channel to transmit the second uplink control information in a target time unit, comprises:
determining, the terminal, according to a position of the time domain symbols used for transmitting the second uplink control channel, a position of at least some time domain symbols from among the time domain symbols, used for transmitting reference symbols, in the first uplink control channel.

7. The communication method according to claim 1, further comprising:
receiving, by the terminal, third configuration information transmitted by the network device, wherein the third configuration information is used for indicating the position of at least some time domain symbols from among the time domain symbols used for transmitting reference symbols in the first uplink control channel.

8. The communication method according to claim 1, wherein using, by the terminal, target time domain symbols in the first uplink control channel to transmit the second uplink control information in a target time unit, comprises:
determining, by the terminal, according to the information carried in the second uplink control information, a sequence that is transmitted on the target domain symbols, wherein sequences corresponding to different information carried in the second uplink control information are different.

9. The communication method according to claim 8, wherein determining, by the terminal, according to the information carried in the second uplink control channel, the sequence that is transmitted on the target domain symbols, comprises:
when the information carried by the second uplink control channel is all negative acknowledgement, determining, the terminal, to transmit a first sequence on the target domain symbol in the first uplink control channel, wherein the first sequence is a sequence that is transmitted on the target time domain symbols when the terminal individually transmits the first uplink control information by using the first uplink control channel.

10. The communication method according to claim 8, wherein an order number of the sequence is determined by the terminal according to an order number of the first uplink control channel.

11.-20. (canceled)

21. A terminal, comprising:
a processing module, configured to determine the transmission of first uplink control information and second uplink control information in a target time unit, if the terminal uses a first uplink control channel when individually transmitting the first uplink information in the target time unit, and if the terminal uses a second uplink control channel when individually transmitting the second uplink control information in the a target time unit, and a number of time domain symbols included in the first uplink control channel is greater than a number of time domain symbols included in the second uplink control channel;
a communication module, configured to transmit, in a target time unit, the second uplink control information by using target time domain symbols in the first uplink control channel, wherein the target time domain symbols are at least some time domain symbols from among the time domain symbols, used for transmitting reference symbols, in the first uplink control channel;
wherein the communication module is further configured to transmit, in the target time unit, the first uplink control information by using time domain symbols, other than the time domain symbols for transmitting reference symbols, in the first uplink control channel.

22. The terminal according to claim 21, wherein before the communication module transmitting, in the target time unit, the second uplink control information by using target time domain symbols in the first uplink control channel, the processing module is further configured to perform at least one of the following steps:
determining that the number of time domain symbols in the second uplink control channel is not greater than the number of time domain symbols used for transmitting the reference symbols in the first uplink control channel;
determining that the number of resource units for transmitting the second uplink control channel is not greater than the number of resource units used for transmitting the reference symbols in the first uplink control channel;
determining that a frequency domain bandwidth used for transmitting the second uplink control channel is not greater than the frequency domain bandwidth used for transmitting the first uplink control channel.

23. The terminal according to claim 21, wherein before the communication module transmitting, in the target time unit, the second uplink control information by using target time domain symbols in the first uplink control channel, the communication module is further configured to receive first configuration information transmitted by a network device, the first configuration information indicating that the terminal supports transmitting the first uplink control information and the second uplink information in a same time unit.

24. The terminal according to claim 21, wherein, before the communication module transmitting, in the target time unit, the second uplink control information by using target time domain symbols in the first uplink control channel, the communication module is further configured to receive second configuration information transmitted by the network device, the second configuration information indicating that the terminal supports transmitting the second uplink control information by using the time domain symbols for transmitting the reference symbols.

25. The terminal according to claim 21, wherein a bandwidth of the target time domain symbols is not less than the bandwidth of other time domain symbols in the first uplink control channel.

26. The terminal according to claim 21, wherein the communication module is configured to determine, according to a position of the time domain symbols used for transmitting the second uplink control channel, a position of at least some time domain symbols from among the time domain symbols used for transmitting reference symbols in the first uplink control channel.

27. The terminal according to claim 21, wherein the communication module is further configured to receive third configuration information transmitted by the network device, the third configuration information indicating the position of at least some time domain symbols from among the time domain symbols used for transmitting reference symbols in the first uplink control channel.

28. The terminal according to claim 21, wherein the communication module is configured to determine, according to the information carried in the second uplink control information, a sequence that is transmitted on the target domain symbols, wherein sequences corresponding to different information carried in the second uplink control information are different.

29. The terminal according to claim 28, wherein the communication module is configured to determine, when the information carried by the second uplink control channel is all negative acknowledgement, the transmission of a first sequence on the target domain symbol in the first uplink control channel, wherein the first sequence is a sequence that is transmitted on the target time domain symbols when the terminal individually transmits the first uplink control information by using the first uplink control channel.

30. The terminal according to claim 28, wherein an order number of the sequence is determined by the terminal according to an order number of the first uplink control channel.

31.-40. (canceled)
